(19) United States
(12) Patent Application Publication
(10) Pub. No.: US 2022/0082401 A1
(43) Pub. Date: Mar. 17, 2022

(54) APPARATUS FOR CONTROLLING DISPLAYING INFORMATION BASED ON AUGMENTED REALITY

(71) Applicants: Hyundai Motor Company, Seoul (KR); Kia Corporation, Seoul (KR); HYUNDAI AUTOEVER Corp., Seoul (KR)

(72) Inventors: Tae Hyun SUNG, Seoul (KR); Bum Hee CHUNG, Seoul (KR); Young Jun YOU, Seoul (KR); Jeong Hyeok SEO, Seoul (KR); Hye Young JEONG, Seoul (KR); Soo In KO, Seoul (KR)

(73) Assignees: Hyundai Motor Company, Seoul (KR); Kia Corporation, Seoul (KR); HYUNDAI AUTOEVER Corp., Seoul (KR)

(21) Appl. No.: 17/410,086

(22) Filed: Aug. 24, 2021

(30) Foreign Application Priority Data
Sep. 15, 2020 (KR) 10-2020-0118479

(51) Int. Cl. G01C 21/36

(52) U.S. Cl. CPC G01C 21/365; G01C 21/3632; G01C 21/3682

(57) ABSTRACT

An information display apparatus, may include a processor configured to display information in augmented reality; and a storage configured to store data and algorithms driven by the processor, wherein the processor is configured to display guidance coordinates, which indicate a position of a target which is accessible by a transportation, and displays auxiliary information related to display coordinates, which indicate an actual position of a target, and the information display apparatus is disposed within a vehicle or outside the vehicle, and when disposed outside the vehicle, is configured to transmit the auxiliary information to the vehicle or a mobile device.

### CROSS-REFERENCE TO RELATED APPLICATION

The present application claims priority to and benefits of Korean Patent Application No. 10-2020-0118479, filed on Sep. 15, 2020, the entire contents of which is incorporated herein for all purposes by this reference.

### BACKGROUND OF THE INVENTION

### Field of the Invention

The present invention relates to an information display apparatus based on augmented reality, and more particularly, to a technique for displaying information (a destination, a stopover area, point of interest (POI) information) of a means of transportation in an augmented reality form.

### Description of Related Art

In general, vehicles (means of transportation) have become essential products in a modern society as their mobility and usability are improved by applying advanced technique, and recently, a head-up display (HUD) has been used to project information onto driver's eyes.

The head-up display is a front display device designed to display driving information related to a means of transportation on front glass of the means of transportation. That is, a head-up display unit is displayed by forming a virtual image such that a driver can recognize various types of information, such as a speed, a fuel level, a temperature, and a warning direction displayed on a vehicle cluster, on windshield glass.

Furthermore, a navigation system is mounted on a recent means of transportation to provide a destination and directions to a driver, and furthermore, in the navigation system to which augmented reality is applied, specific information may be displayed in a form of augmented reality. However, accuracy and diversity of information provided by use of augmented reality in the navigation system is poor.

The information disclosed in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing an information display apparatus configured for minimizing a sense of guidance coordinates by accurately displaying information related to a means of transportation based on augmented reality.

The technical objects of the present invention are not limited to the objects mentioned above, and other technical objects not mentioned may be clearly understood by those skilled in the art from the description of the claims.

Various aspects of the present invention are directed to providing an information display apparatus, including: a processor configured to display information in augmented reality; and a storage configured to store data and algorithms driven by the processor, wherein the processor is configured to display guidance coordinates, which indicate a position of a target which is accessible by a transportation, and displays auxiliary information related to display coordinates, which indicate an actual position of a target, and the information display apparatus is disposed within a vehicle or outside the vehicle, and when disposed outside the vehicle, is configured to transmit the auxiliary information to the vehicle or a mobile device.

In various exemplary embodiments of the present invention, the auxiliary information may include direction and distance information from guidance coordinates of the target to an actual position of the target.

In various exemplary embodiments of the present invention, the processor may display at least one of map information related to a position of the display coordinates, path information to the display coordinates, and information related to the transportation when there is a position difference in the guidance coordinates and the display coordinates.

In various exemplary embodiments of the present invention, the processor may display the map information related to the position of the display coordinates or the path information to the display coordinates as a mini map, or displays information related to the display coordinates in connection with display information related to the guidance coordinates.

Various aspects of the present invention are directed to providing an information display apparatus, including: a processor configured to display point of interest (POI) information in augmented reality; and a storage configured to store data and algorithms driven by the processor, wherein the processor is configured to select guidance coordinates, which are a position where a means of transportation can reach a target corresponding to a POI, or display coordinates, which are an actual position of the POI, as a position of the POI, to display the POI information at the selected position, and the information display apparatus is disposed within a vehicle or outside the vehicle, and when disposed outside the vehicle, is configured to transmit display information to the vehicle or a mobile device.

In various exemplary embodiments of the present invention, the processor may select a position of a road close to an actual position of the POI as a position of the POI when there is no information related to guidance coordinates of the POI.

In various exemplary embodiments of the present invention, the processor may select a displayable area based on augmented reality in front of a means of transportation, and may display the POI information on the displayable area when the position of the POI exists on the displayable area.

In various exemplary embodiments of the present invention, the processor may select the displayable area by including at least one of a radius angle, a distance, and presence or absence of an obstacle based on a host vehicle.

Various aspects of the present invention are directed to providing an information display device including: a processor configured to display information in augmented reality; and a storage configured to store data and algorithms driven by the processor, wherein the processor displays information related to an area which is not displayable or difficult to display because the area is out of view or is covered by an obstacle in a displayable area in the augmented reality, and the information display apparatus is disposed within a vehicle or outside the vehicle, and when disposed outside the vehicle, is configured to transmit display information to the vehicle or a mobile device.

In various exemplary embodiments of the present invention, the processor may display summarized information in the displayable area by grouping some or all of targets of the area which is not displayable or difficult to display.

In various exemplary embodiments of the present invention, the processor may display directions, numbers, and average available information related to the targets at an entrance point of each road connected by a crossroad.

In various exemplary embodiments of the present invention, the processor may adjust and displays gradients and angles of the targets at an entrance point of each road connected by a crossroad depending on curvatures of the roads.

In various exemplary embodiments of the present invention, the processor may count a number of the targets up to a predetermined number of links based on an entry link, and displays the number of the targets and average available information.

In various exemplary embodiments of the present invention, the processor may count a number of the targets by selecting a link positioned close to a host vehicle in a case where a link which is counted with another entry point is overlapped when there is a plurality of entry points in a path.

In various exemplary embodiments of the present invention, the processor, when the link which is counted becomes a main line again, may count and display a number of targets up to a link immediately before the main line.

Various aspects of the present invention are directed to providing an information display apparatus, including: a processor configured to display information in augmented reality; and a storage configured to store data and algorithms driven by the processor, wherein the processor adjust a moving speed of the target or a size of the target displayed in an augmented reality form according to a relative position of the target, and the information display apparatus is disposed within a vehicle or outside the vehicle, and when disposed outside the vehicle, is configured to transmit display information to the vehicle or a mobile device.

In various exemplary embodiments of the present invention, the processor may increase the size of the displayed target as a relative distance to the target increases.

In various exemplary embodiments of the present invention, the processor may increase the moving speed of the displayed target as a relative distance to the target increases.

In various exemplary embodiments of the present invention, the processor may divide POIs for each category, and variably adjusts the size or the moving speed of the target depending on a relative position according to importance of a category preferred by a user.

According to the present technique, it is possible to minimize a sense of heterogeneity by accurately displaying information related to a means of transportation based on augmented reality.

Furthermore, various effects which may be directly or indirectly identified through the present document may be provided.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A illustrates a block diagram showing a configuration of an information display apparatus based on augmented reality according to various exemplary embodiments of the present invention.

FIG. 1B illustrates a block diagram showing a configuration of an information display apparatus based on augmented reality according to various exemplary embodiments of the present invention.

FIG. 2 illustrates an example of a screen displaying a destination or a stopover area according to various exemplary embodiments of the present invention.

FIG. 3A illustrates an example of a screen displaying POI information according to various exemplary embodiments of the present invention.

FIG. 3B illustrates a view for describing a display type of POI information according to various exemplary embodiments of the present invention.

FIG. 4A illustrates an example of a screen displaying display restriction information according to various exemplary embodiments of the present invention.

FIG. 4B illustrates an enlarged view of display restriction information according to various exemplary embodiments of the present invention.

FIG. 5 illustrates an example of a screen grouping display restriction information according to various exemplary embodiments of the present invention.

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, some exemplary embodiments of the present invention will be described in detail with reference to exemplary drawings. It may be noted that in adding reference numerals to constituent elements of each drawing, the same constituent elements have the same reference numerals as possible even though they are indicated on different drawings. Furthermore, in describing exemplary embodiments of the present invention, when it is determined that detailed descriptions of related well-known configurations or functions interfere with understanding of the exemplary embodiments of the present invention, the detailed descriptions thereof will be omitted.

In describing constituent elements according to various exemplary embodiments of the present invention, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the Field of the Invention to which various exemplary embodiments of the present invention pertains (those skilled in the art) unless they are differently defined. Terms defined in a generally used dictionary shall be construed to have meanings matching those in the context of a related art, and shall not be construed to have idealized or excessively formal meanings unless they are clearly defined In various exemplary embodiments of the present invention.

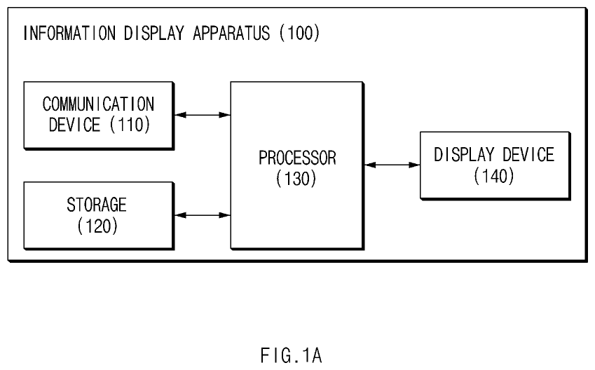

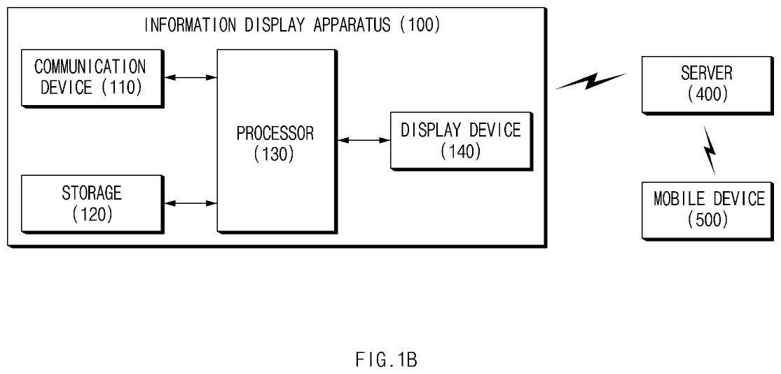

Hereinafter, various exemplary embodiments of the present invention will be described in detail with reference to FIG. 1A to FIG. 5.

FIG. 1A illustrates a block diagram showing a configuration of an information display apparatus of a means of transportation according to various exemplary embodiments of the present invention, and FIG. 1B illustrates a block diagram showing a configuration of an information display apparatus based on augmented reality according to various exemplary embodiments of the present invention.

The means of transportation may include a four-wheeled means of transportation, such as a vehicle or a truck, a two-wheeled means such as a motorcycle or a bicycle, and all movable means such as an aircraft or a ship, the information display apparatus may display information such as a destination, a stopover area, a point of interest (POI), and a driving state of a means of transportation, and may be implemented as a navigation system, an audio video navigation (AVN), or the like.

According to various exemplary embodiments of the present invention, the information display apparatus 100 may be implemented inside the means of transportation. In the instant case, as illustrated in FIG. 1A, the information display apparatus 100 may be integrally formed with internal control units of the means of transportation, and may be implemented as a separate device to be connected to the control units of the means of transportation by a separate connecting means. Furthermore, the information display apparatus 100 may be configured in a form of a server 400 outside the vehicle as illustrated in FIG. 1B, and when positioned outside the vehicle, the server 400 transmits and displays driving information to the in-vehicle display device 100 or the mobile device 500. In the instant case, the mobile device 500 may include all mobile communication terminals having a display device, such as a smart phone, a personal digital assistant (PDA), a portable multimedia player (PMP), a digital camera, a portable game machine, an MP3 player, a smart key, a tablet PC, as a user terminal. When driving information is transmitted from an outside of the vehicle to the means of transportation, it may be transmitted from a device or a server outside the vehicle to an in-vehicle device, and the in-vehicle device may include, e.g., a cluster, a head-up display, a navigation terminal, an audio, a video, a navigation (AVN), and the like.

Furthermore, the information display apparatus 100 in various exemplary embodiments of the present invention may be applied to an autonomous driving control vehicle including, e.g., advanced driver assistance systems (ADAS), smart cruise control (SCC), and forward collision warning (FCW).

The information display apparatus 100 may display guidance coordinates, which indicate a position of a target which is accessible by the means of transportation, and may also display auxiliary information related to display coordinates, which indicate an actual position of the target.

Furthermore, the information display apparatus 100 may select guidance coordinates, which indicate a position of a target corresponding to a point of interest (POI), which is accessible by the means of transportation, as a position of the POI, to display POI information at the selected position.

Furthermore, the information display apparatus 100 may display information related to an area which is not displayable or difficult to display because it is out of view or is covered by an obstacle in a displayable area in augmented reality.

Furthermore, the information display apparatus 100 may adjust a moving speed or a size of the target displayed in an augmented reality form depending on a relative position of the target.

According to the exemplary embodiment of the present invention, the information display apparatus 100 which is operated as the above may be implemented in a form of an independent hardware device including a memory and a processor that processes each operation, and may be driven in a form included in other hardware devices such as a microprocessor or a general purpose computer system.

Referring to FIG. 1A, the information display apparatus 100 of the means of transportation may include a communication device 110, a storage 120, and a processor 130.

The communication device 110, which is a hardware device implemented with various electronic circuits to transmit and receive signals through a wireless or wired connection, may perform V2I communication by use of an in-vehicle network communication technique or a wireless Internet access or short range communication technique with servers, infrastructure, and other vehicles outside the vehicle in various exemplary embodiments of the present invention. Herein, in-vehicle communication may be performed through controller area network (CAN) communication, local interconnect network (LIN) communication, or flex-ray communication as the in-vehicle network communication technique. Furthermore, the wireless communication technique may include wireless LAN (WLAN), wireless broadband (Wibro), Wi-Fi, Worldwide Interoperability for Microwave Access (WiMAX), etc. Furthermore, short-range communication technique may include Bluetooth, ZigBee, ultra wideband (UWB), radio frequency identification (RFID), infrared data association (IrDA), and the like.

As an example, the communication device 110 may receive traffic information, road information, information for display based on augmented reality, and the like from an external server.

The storage 120 may store information received by the communication device 110, data obtained by the processor 130, data and/or algorithms required for the processor 130 to operate, and the like. In the instant case, the information received by the communication device 110 may include driving information for display based on augmented reality.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The processor 130 may be electrically connected to the communication device 110, the storage 120, and the like, may electrically control each component, and may be an electrical circuit that executes software commands, performing various data processing and calculations described below. The processor 130 may be, e.g., an electronic control unit (ECU), a micro controller unit (MCU), or other subcontrollers mounted in the vehicle.

When a target such as a destination or a stopover area is displayed, the processor 130 may display auxiliary information related to an actual position of the target.

In the case of displaying a destination or a stopover area based on an existing map, even when information related to the destination or the stopover area is positioned in an area to which the means of transportation is not accessible, a corresponding position may be displayed on the map, and an area to which the means of transportation is accessible may also be separately displayed. For example, a destination such as a temple or a park in a mountainous area may be accessible to the parking lot entrance, and an actual destination may be far from the parking lot entrance.

However, in existing augmented reality, due to limitation of a display area, information related to all positions cannot be displayed, so if possible, only positions that are accessible by the means of transportation could be displayed.

Accordingly, in the case of displaying a destination, a stopover area, or the like, the processor 130 in various exemplary embodiments of the present invention displays a position (hereinafter referred to as display coordinates) of an actual point of the destination or the stopover area, but when the means of transportation cannot move to the corresponding actual point, path guidance is performed to an accessible place (hereinafter, guidance coordinates).

In the instant case, when information is displayed based on augmented reality, an area configured for displaying information is limited depending on a field of view or a view angle of an imaging device, and thus there are many cases where display coordinates cannot be displayed, and when only guidance coordinates are displayed, information related to the display coordinates cannot be provided to a user.

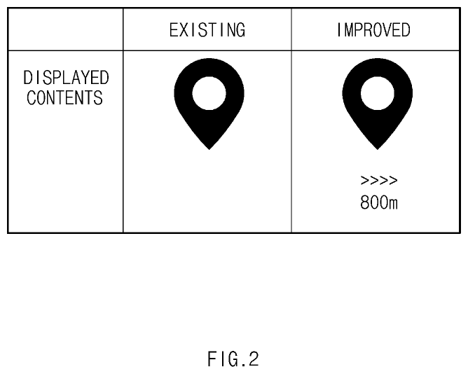

Accordingly, the processor 130 may display information similar to the guidance coordinates, but may simultaneously display information related to the display coordinates. FIG. 2 illustrates an example of a screen displaying a destination or a stopover area according to various exemplary embodiments of the present invention. Referring to FIG. 2, only guidance coordinates for a destination or a stopover area are displayed in conventional augmented reality, but it may be seen that display coordinate information is displayed together with the guidance coordinates in various exemplary embodiments of the present invention. For example, display coordinate information to move 800 meters to the right from a guidance coordinate point is also displayed.

In the present way, the processor 130 may preferentially display guidance coordinates of a point replacing the position of the destination or the stopover area, and may overcome a limitation of display by displaying direction or distance information to the destination or stopover area. Accordingly, the user ca first check the guidance coordinates, as the replaced point, and move to an actual destination or stopover area based on the display coordinate information.

When there is a difference between the guidance coordinates and the display coordinates, the processor 130 may provide display coordinate information as detailed information by selecting corresponding guidance coordinates or through a separate button input. For example, when a temple (display coordinates) is the destination and a separate mark is made to replace the parking lot entrance (guidance coordinates), the processor 130 may provide information to a destination (display coordinates) by selecting the guidance coordinates of the entrance to the parking lot entrance.

Furthermore, when there is a difference between the guidance coordinates and the display coordinates, the processor 130 may switch them to a general map display method instead of augmented reality, to display the display coordinates. That is, when there is a difference between the guidance coordinates and the display coordinates, the processor 130 may display the display coordinates by use of map information, route information (including distance information, direction information, etc.), a minimap, etc., and may display a path from the guidance coordinates to the display coordinates, a moving time and a moving distance through walking or the means of transportation. Furthermore, the processor 130 may display information in association with display information related to the guidance coordinates in some cases.

The processor 130 may display POI information in the augmented reality form. Conventionally, when the POI information is displayed in augmented reality, there were cases where a standard for the display position was ambiguous, so that it was not possible to display it at a precise position, or at a position that the means of transportation could not approach. That is, in the past, when the POI information is displayed based on augmented reality, a position for the information may be uncertain, and it was difficult to indicate where the information may be displayed.

When the POI information is displayed based on augmented reality, the processor 130 overcomes the limitation by selecting the position as follows.

First, the processor 130 may select the corresponding coordinates as POI position when there are guidance coordinates for a corresponding POI. In the instant case, the guidance coordinates are not the position where the POI is actually positioned, but the POI position, which is a position on or close to the road, may be selected as guidance coordinates, and a guidance of path search may be terminated based on the guidance coordinates.

When there are no guidance coordinates in the corresponding POI, the processor 130 may select the POI position by matching a nearby road based on actual coordinates of the corresponding POI.

Furthermore, the processor 130 may display corresponding POI informations when there is a POI position which is selected in a displayable range in front of the means of transportation. In the instant case, the displayable range may include a range selected by including at least one of a radius angle, a distance, and the presence or absence of an obstacle based on the host vehicle. Accordingly, the processor 130 may select guidance coordinates, which are a position where the means of transportation can reach a target corresponding to the POI, or display coordinates, which are an actual position of the POI, as the position of the POI, to display POI information at the selected position.

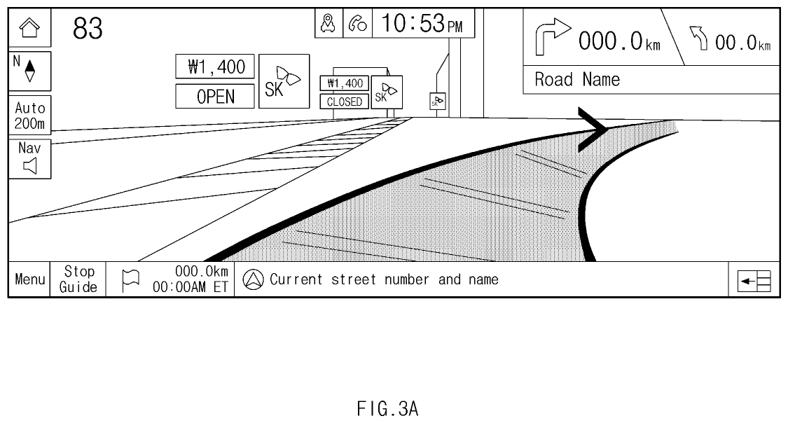

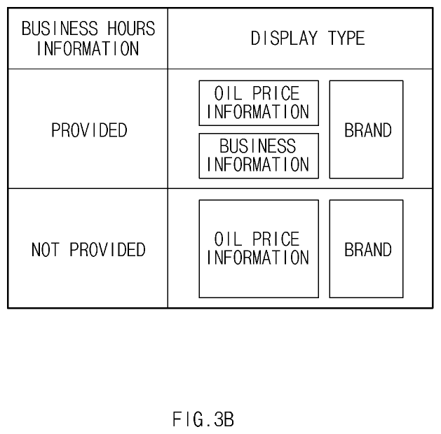

FIG. 3A illustrates an example of a screen displaying POI information according to various exemplary embodiments of the present invention, and FIG. 3B illustrates a view for describing a display type of POI information according to various exemplary embodiments of the present invention. Referring to FIG. 3A, gas station information which is registered as a POI may be displayed on a map based on augmented reality. In the instant case, the gas station information may be displayed depending on a predetermined display type as illustrated in FIG. 3B, and in FIG. 3A, an example of displaying oil price information, business information (open, closed), and brand information is disclosed. In the instant case, it may be seen that a POI position of the position close to the road is displayed.

Accordingly, the processor 130 may display position information related to each POI by use of guidance coordinates, or when there is no information related to the guidance coordinates, may improve accuracy or usability of the display position by matching it to a nearby road.

Furthermore, due to a characteristic of augmented reality, when there is a limit in the display area and there are other objects/buildings, objects may be overlapped and displayed, and thus the processor 130 may define a displayable range based on a radius angle, a distance, and the presence or absence of an obstacle based on the host vehicle, and thereby may enhance realism of display information. In the instant case, the processor 130 may select the displayable range through structuring by use of a node and an interpolation point.

The processor 130 may display information on an area which is not displayable or is difficult to display in a displayable area in augmented reality. Since there is no limit to the display area in a form of a top view on an existing general map, information over an obstacle from a current position of the host vehicle may be displayed, so there is no consideration for display information when the field of view is limited, such as in augmented reality. In other words, in the real world, when right turn is performed at an intersection in front, the field of view is limited due to surrounding buildings, so it is impossible to know what kind of information is provided. Accordingly, in the augmented reality, in the case where the intersection is taken as an example, when the right turn is performed at the intersection, it is limited to display information in a corresponding position as the augmented reality. Accordingly, it is difficult to know whether there is a parking lot POI when the right turn is performed at the intersection, for example.

Accordingly, an area which is impossible to display or is difficult to display may include an area which is not visible because the field of view is limited by surrounding buildings or the like.

The processor 130 may display information related to an area which is impossible to display or is difficult to display as summarized information in a displayable area by grouping some or all of the information to display the information related to the area which is impossible to display or is difficult to display as summarized information in the displayable area. For example, there are several parking lot POIs in a right-turn direction at the intersection where it can turn right, whether a corresponding parking lot is available, and the like may be displayed. In the instant case, the information related to the area which is impossible to display or is difficult to display may be obtained from map information related to, e.g., a navigation system.

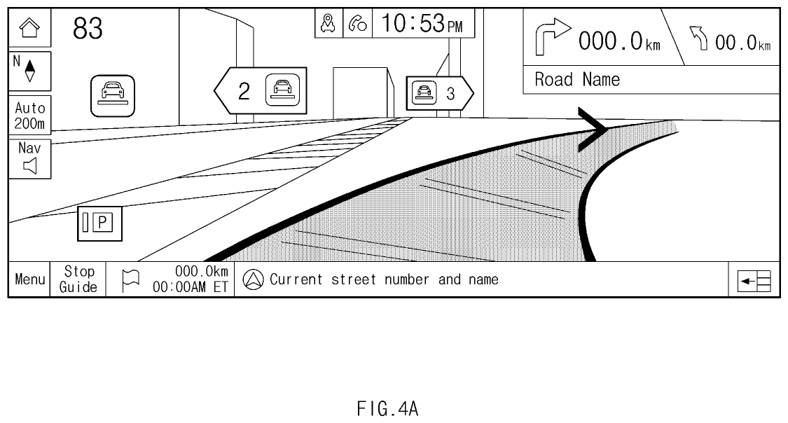

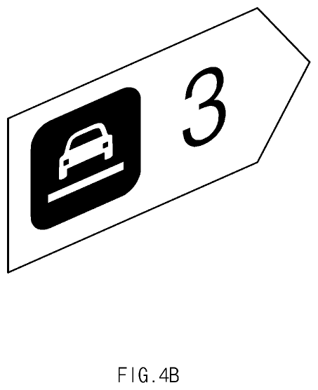

FIG. 4A illustrates an example of a screen displaying display restriction information according to various exemplary embodiments of the present invention, and FIG. 4B illustrates an enlarged view of display restriction information according to various exemplary embodiments of the present invention. Referring to FIG. 4A, when three gas stations that are not currently visible exist when it turns right on the driving road, the processor 130 may display POI information indicating that three gas stations currently operating exist in a right direction thereof. That is, the processor 130 may group parking lot information at an entrance point of each road connected by a crossroad, and may display a direction thereof, a number, and average available information. The processor 130 may display POI information which is similar to a curvature of a rotation point as illustrated in FIG. 4B by adjusting a graphic gradient and an angle depending on an angle of an entrance point of a crossroad.

Accordingly, the processor 130 may bring information (information which is impossible or difficult to display) out of a field of view or covered by an obstacle to a displayable area and display it.

Even in cases where display is restricted as in augmented reality, the processor 130 may provide sufficient information to a user at a branch point such as an intersection.

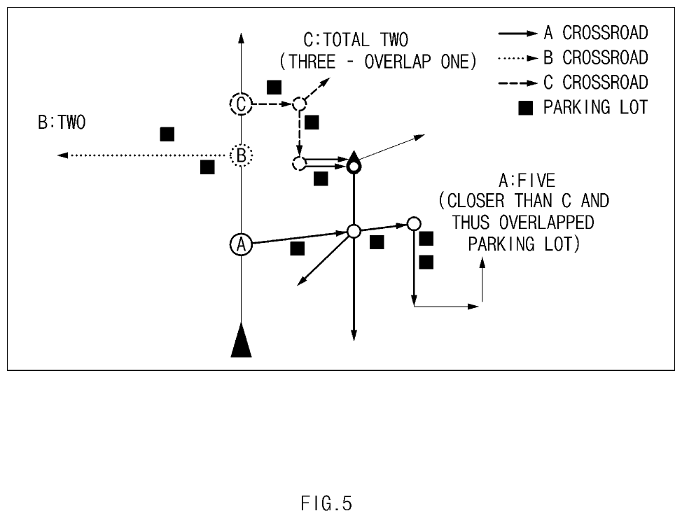

FIG. 5 illustrates an example of a screen grouping display restriction information according to various exemplary embodiments of the present invention. Referring to FIG. 5, the processor 130 may group parking lot information for each crossroad. There are five parking lots at a crossroad A, two parking lots at a crossroad B, and two parking lots at crossroad C.

The processor 130 may count up to a third link based on an entry link and display a combination of the number of parking lots and average available information.

When a link which is counted with another entry point is overlapped, the processor 130 may include a number of parking lots of the link in a link close to the host vehicle. In FIG. 5, since the parking lots overlapping at the crossroads A and C are closer to the crossroad A, they are included in a group of POIs of the crossroad A.

When the link which is counted becomes a main line again, the processor 130 may count and display only up to a link immediately before the main line. For example, when the third link becomes a main line, the link may be excluded from counting.

The processor 130 may actively adjust a display size of a target depending on relative position movement of the object. In the past, when information related to perspective is applied, a consistent ratio of perspective is applied, and in some cases, a long distance or distorted perspective may cause a size of displayed information to be too small or large. In the instant case, it is necessary to display a size which is easy to recognize to a user.

Accordingly, the processor 130 may variably adjust and display the size of the target depending on a relative position rather than size display and normal perspective depending on a distance.

TABLE 1

Virtual size of object

| Remaining distance | Existing | Improved |
|---|---|---|
| 10 m | 5 m * 5 m | 5 m * 5 m |
| 20 m | | 7 m * 7 m |
| 50 m | | 9 m * 9 m |
| 100 m | | 10 m * 10 m |

Referring to Table 1, it may be seen that a virtual size of an object (target) was conventionally constant even when a remaining distance increased, while the virtual size of the object (target) is increased and displayed in various exemplary embodiments of the present invention (improved).

Furthermore, the processor 130 may divide POIs for each category, and may variably adjust the size of the target according to a relative position depending on importance of a category preferred by a user.

Accordingly, the processor 130 may adjust the target which is excessively small or large to a level which is easy for the user to recognize by reflecting an adjustment ratio of the perspective depending on the distance differently from the real world, improving user's visibility.

The processor 130 may actively adjust a moving speed of a target depending on relative position movement of the object. Previously, the moving speed of the target was consistently applied regardless of the position of the object, so that the speed of the target could not be displayed smoothly. For example, in the case where a close distance is viewed greater than normal and a far distance is viewed smaller than normal due to a distortion of the perspective, even when the object moves at a same speed, the object at the close distance may move very rapidly and the object at a distance may move very slowly.

That is, when there is an object whose position changes in augmented reality, a change amount in the close distance is larger depending on the perspective even at a same speed. Accordingly, even at a same speed, it may be displayed at a speed which is not recognized by the user at the close distance, and the present becomes larger when the perspective is distorted.

Accordingly, the processor 130 variably applies the moving speed of the object depending on a relative object position or a host vehicle state (e.g., vehicle speed).

TABLE 2

| Relative distance | Existing | Improved |
|---|---|---|
| 10 m | 100 KPH | 30 KPH |
| 20 m | 100 KPH | 40 KPH |
| 50 m | 100 KPH | 70 KPH |
| 100 m | 100 KPH | 100 KPH |

In Table 2, even when the relative distance changes, the moving speed of the target is constantly applied in the past, but in various exemplary embodiments of the present invention (improved), it may be seen that the moving speed changes depending on the relative distance.

Furthermore, the processor 130 may divide POIs for each category, and may variably adjust the speed of the object according to a relative object position depending on importance of a category preferred by a user.

Accordingly, the processor 130 changes the moving speed depending on the position of the object so that the moving speed of the object may be supplemented even when the perspective is distorted. The processor 130 slows the movement of an object at the close distance such that it appears to be close to the normal speed when displayed, and accelerates the movement of the object at the far distance such that it appears to be close to the normal speed when displayed. Accordingly, the processor 130 may increase the user's visibility by limiting an excessive or excessive change in information provided to the user.

The display device 140 is controlled by the processor 130 to display information based on augmented reality. As an example, the display device 140 may be implemented as a head-up display (HUD), a cluster, an audio video navigation (AVN), or a human machine interface (HMI). Furthermore, the display device 140 may include at least one of a liquid crystal display (LCD), a thin film transistor liquid crystal display (TFT LCD or thin film transistor-LCD), a light emitting diode (LED) display, an organic light emitting diode (OLED or organic LED) display, an active OLED (AMOLED or active matrix OLED) display, a flexible display, a bended display, and a 3D display. Some of these displays may be implemented as a transparent display formed of a transparent or translucent type such that the outside may be viewed. Furthermore, the display device 140 may be provided as a touch screen including a touch panel, and may be used as an input device as well as an output device.

Accordingly, according to various exemplary embodiments of the present invention, detailed information may be provided using general map information, mini-map, etc. when auxiliary information is displayed on the actual point of the target such as a destination or a stopover area based on augmented reality, and the display coordinates (actual position) of the target and guidance coordinates (position where the means of transportation can enter) are different. That is, in various exemplary embodiments of the present invention, when it is difficult to match the position of the target such as the destination or the stopover area in the real world, it is possible to provide sufficient information to the user based on the augmented reality by displaying the position on the map of the destination or the stopover area on the actual image.

Furthermore, according to various exemplary embodiments of the present invention, POI information may be displayed in the augmented reality, and when there is no guidance coordinates for the POI information, a displayable range may be defined and POI information may be displayed, enhancing realism of the POI information.

According to various exemplary embodiments of the present invention, it is possible to provide sufficient information to a user by bringing information related to the area which is impossible to display or is difficult to display in the augmented reality to the displayable area.

Furthermore, according to various exemplary embodiments of the present invention, the visibility of a user may be improved by actively adjusting the display size and the moving speed of the target displaying the corresponding object depending on relative position movement of the object.

Therefore, according to various exemplary embodiments of the present invention, user convenience may be increased by minimizing the sense of guidance coordinates in the display of the current state and sense of speed when displaying information in a form of augmented reality, by minimizing the sense of guidance coordinates in the display of objects between the real world and the augmented reality, maximizing an effect of emphasis on the object of the real world, minimizing dependence on a recognition rate of the object of the real world, and by displaying the information related to the area which is impossible to display or is difficult to display as summarized information in the displayable area.

The above description is merely illustrative of the technical idea of the present invention, and those skilled in the art to which various exemplary embodiments of the present invention pertains may make various modifications and variations without departing from the essential characteristics of the present invention.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An information display device comprising:
a processor configured to display information in augmented reality; and
a storage configured to store data and algorithms driven by the processor,
wherein the processor is configured to display guidance coordinates, which indicate a position of a target which is accessible by a transportation, and to display auxiliary information related to display coordinates, which indicate an actual position of the target, and
wherein the information display apparatus is disposed within a vehicle or outside the vehicle, and when disposed outside the vehicle, is configured to transmit the auxiliary information to the vehicle or a mobile device.

2. The information display device of claim 1, wherein the auxiliary information includes direction and distance information from the guidance coordinates of the target to the actual position of the target.

3. The information display device of claim 1, wherein the processor is configured to display at least one of map information related to a position of the display coordinates, path information to the display coordinates, and information related to the transportation when there is a position difference in the guidance coordinates and the display coordinates.

4. The information display device of claim 3, wherein the processor is configured to display the map information related to the position of the display coordinates or the path information to the display coordinates as a mini map, or is configured to display information related to the display coordinates in connection with display information related to the guidance coordinates.

5. An information display device comprising:
a processor configured to display point of interest (POI) information in augmented reality; and
a storage configured to store data and algorithms driven by the processor,
wherein the processor is configured to select guidance coordinates, which are a position where a transportation can reach a target corresponding to a POI, or display coordinates, which are an actual position of the POI, as a position of the POI, to display the POI information at the selected position, and
wherein the information display apparatus is disposed within a vehicle or outside the vehicle, and when disposed outside the vehicle, is configured to transmit display information to the vehicle or a mobile device.

6. The information display device of claim 5, wherein the processor is configured to select a position of a road adjacent to the actual position of the POI as the position of the POI when there is no information related to guidance coordinates of the POI.

7. The information display device of claim 5,
wherein the processor is configured to select a displayable area based on the augmented reality in a front of the transportation, and
wherein the processor is configured to display the POI information on the displayable area when the position of the POI exists on the displayable area.

8. The information display device of claim 7, wherein the processor is configured to select the displayable area by including at least one of a radius angle, a distance, and presence or absence of an obstacle based on the vehicle.

9. An information display device comprising:
a processor configured to display information in augmented reality; and
a storage configured to store data and algorithms driven by the processor,
wherein the processor is configured to display information related to an area which is not displayable or difficult to display while the area is out of view or is covered by an obstacle in a displayable area in the augmented reality, and
wherein the information display apparatus is disposed within a vehicle or outside the vehicle, and when disposed outside the vehicle, is configured to transmit display information to the vehicle or a mobile device.

10. The information display device of claim 9, wherein the processor is configured to display summarized information in the displayable area by grouping at least one of targets of the area which is not displayable or difficult to display.

11. The information display device of claim 10, wherein the processor is configured to display directions, numbers, and average available information related to the targets at an entrance point of each road connected by a crossroad.

12. The information display device of claim 10, wherein the processor is configured to adjust and display gradients and angles of the targets at an entrance point of each road connected by a crossroad depending on a curvature of each road.

13. The information display device of claim 10, wherein the processor is configured to count a number of the targets up to a predetermined number of links based on an entry link, and to display the number of the targets and average available information.

14. The information display device of claim 10, wherein the processor is configured to count a number of the targets by selecting a link positioned adjacent to the vehicle in a case where a link which is counted with another entry point is overlapped when there is a plurality of entry points in a path.

15. The information display device of claim 10, wherein the processor, when a link which is counted becomes a main line again, is configured to count and display a number of the targets up to a link immediately before the main line.

16. An information display device comprising:
a processor configured to display information in augmented reality; and
a storage configured to store data and algorithms driven by the processor,
wherein the processor is configured to adjust a moving speed of a target or a size of the target displayed in an augmented reality form according to a relative position of the target, and
wherein the information display apparatus is disposed within a vehicle or outside the vehicle, and when disposed outside the vehicle, is configured to transmit display information to the vehicle or a mobile device.

17. The information display device of claim 16, wherein the processor is configured to increase a size of the displayed target as a relative distance to the target increases.

18. The information display device of claim 16, wherein the processor is configured to increase the moving speed of the displayed target as a relative distance to the target increases.

19. The information display device of claim 16, wherein the processor is configured to divide point of interest (POI)s for each category, and to variably adjust the size or the moving speed of the target depending on a relative position according to importance of a category preferred by a user.
